(19) United States
(12) Patent Application Publication
(10) Pub. No.: US 2024/0162543 A1
(43) Pub. Date: May 16, 2024

(54) LAMINATED BATTERY, BATTERY MODULE, AND METHOD OF MANUFACTURING LAMINATED BATTERY

(71) Applicant: TOYOTA JIDOSHA KABUSHIKI KAISHA, Toyota-shi Aichi-ken (JP)

(72) Inventors: Masashi CHIHARA, Nagoya-shi Aichi-ken (JP); Yutaka HIDAKA, Toyota-shi Aichi-ken (JP); Kenichi KAKISHITA, Nagoya-shi Aichi-ken (JP)

(73) Assignee: TOYOTA JIDOSHA KABUSHIKI KAISHA, Toyota-shi Aichi-ken (JP)

(21) Appl. No.: 18/388,365

(22) Filed: Nov. 9, 2023

(30) Foreign Application Priority Data
Nov. 10, 2022 (JP) 2022-180636

(51) Int. Cl. H01M 50/184; H01M 10/0585; H01M 50/119; H01M 50/121; H01M 50/129; H01M 50/191; H01M 50/193; H01M 50/197; H01M 50/207

(52) U.S. Cl. CPC H01M 50/184; H01M 10/0585; H01M 50/119; H01M 50/121; H01M 50/129; H01M 50/191; H01M 50/193; H01M 50/197; H01M 50/207

(57) ABSTRACT

A laminated battery has a battery element and a laminate exterior body that seals the battery element. The laminate exterior body includes at least a resin layer and a metal layer that are laminated. The battery element includes substantially right-angled portions, and horizontal portions that are horizontal shaped. At 80% or more of areas of the metal layer that face the substantially right-angled portions of the battery element, a thickness T1 of the metal layer, with respect to a thickness T2 of the metal layer of the laminate exterior body that faces the horizontal portions of the battery element, satisfies a relationship of formula |T1−T2|/T2×100(%)≤10%.

### CROSS-REFERENCE TO RELATED APPLICATION

This application is based on and claims priority under 35 USC 119 from Japanese Patent Application No. 2022-180636 filed on Nov. 10, 2022, the disclosure of which is incorporated by reference herein.

### BACKGROUND

### Technical Field

The present disclosure relates to a laminated battery, a battery module, and a method of manufacturing a laminated battery.

### Related Art

A battery such as a lithium ion secondary battery or the like usually has an electrode body having a positive electrode collector, a positive electrode active material layer, an electrolyte layer, a negative electrode active material layer and a negative electrode collector. The electrode body is, for example, sealed in an internal space that is surrounded by an exterior member.

Japanese Patent Application Laid-Open (JP-A) No. 2011-108623 discloses a lithium polymer secondary battery including an electrode assembly, an exterior member that surrounds the exterior of the electrode assembly, and a first and second cover that seal the exterior member, and in which a first electrode terminal and a second electrode terminal are pulled-out to the exterior via the first cover and the second cover, respectively. Note that a laminate film is disclosed as the exterior member in JP-A No. 2011-108623.

JP-A No. 2017-174555 discloses a laminated battery using a laminate film that is made to accord with the shape of an electrode body and that is subjected to an embossing step in advance.

### SUMMARY

Patent Document 2 discloses using a laminate film, that is made to accord with the shape of an electrode body corresponding to a battery element and that is subjected to an embossing step in advance, as the laminate exterior body at a laminated battery. However, in a case in which an embossing step is carried out, the laminate exterior body stretches at the places that have been processed. Therefore, the thickness of the metal layer at the laminate exterior body at positions facing the substantially right-angled portions of the battery element becomes thin, and there are cases in which breakage occurs at these portions that become thin. As a result, the sealability of the battery element by the laminate exterior body deteriorates.

The present disclosure was made in view of the above-described circumstances, and an object thereof is to provide a laminated battery at which breakage of a metal layer of a laminate exterior body at positions facing substantially right-angled portions of a battery element is suppressed and at which good sealability of the battery element by the laminate exterior body is realized, and a battery module having the laminated battery, and a method of manufacturing the laminated battery.

Techniques for solving the above-described problem include the following aspects.

A laminated battery of a first aspect of the present disclosure, including:
a battery element; and
a laminate exterior body that seals the battery element,
wherein:
the laminate exterior body includes at least a resin layer and a metal layer that are laminated,
the battery element includes substantially right-angled portions having angles greater than or equal to 80° and less than or equal to 100°, and horizontal portions that are horizontal shaped, and
at 80% or more of areas of the metal layer that face the substantially right-angled portions of the battery element, a thickness T1 of the metal layer satisfies a relationship of the following formula with respect to a thickness T2 of the metal layer of the laminate exterior body that faces the horizontal portions of the battery element:

|T1−T2|/T2×100(%)≤10%.

The laminated battery of a second aspect according to the present disclosure is the laminated battery of the first aspect, wherein a ratio (|T3−T2|/T2×100(%)) of a difference between a thickness T3 of the metal layer at positions that face the horizontal portions of the battery element and are 1 mm from positions that face the substantially right-angled portions of the battery element, and the thickness T2 of the metal layer of the laminate exterior body that faces the horizontal portions of the battery element, is less than or equal to 10%.

The laminated battery of a third aspect according to the present disclosure is the laminated battery of the first aspect or the second aspect, wherein, at positions facing the substantially right-angled portions of the battery element, the laminate exterior body has crest-folded bent portions at three or more places and trough-folded bent portions at one or more places.

A battery module of a forth aspect of the present disclosure having plural laminated batteries that are stacked in a thickness direction, wherein each of the laminated batteries comprises the laminated battery of any one of the first aspect to the third aspect.

A method of manufacturing a laminated battery of a fifth aspect of the present disclosure having:
a battery element including substantially right-angled portions having angles greater than or equal to 80° and less than or equal to 100°, and horizontal portions that are horizontal shaped; and
a laminate exterior body that seals the battery element, and at which at least a resin layer and a metal layer are laminated,
the method including:
a bending step of forming bend lines by bending molding at positions of the laminate exterior body that face the substantially right-angled portions of the battery element at a time at which the laminate exterior body seals the battery element; and
a sealing step of sealing the battery element by the laminate exterior body that has the bend lines.

The method of manufacturing a laminated battery of a sixth aspect according to the present disclosure is the method of manufacturing a laminated battery of the fifth aspect, wherein:
the battery element includes an electrode body, and side surface members disposed at side surface portions of the electrode body, and
in the bending step, at a time of forming the bend lines at the laminate exterior body, the bend lines are not formed at positions of the laminate exterior body that face the side surface members.

The method of manufacturing a laminated battery of a seventh aspect according to the present disclosure is the method of manufacturing a laminated battery of the fifth aspect or the sixth aspect, wherein:
a mold, which has an arc-shaped surface at at least one surface that contacts the laminate exterior body, is used in the bending molding in the bending step, and
the arc-shaped surface contacts positions of the laminate exterior body that face a horizontal portion of the battery element at the time at which the laminate exterior body seals the battery element.

The method of manufacturing a laminated battery of a eighth aspect according to the present disclosure is the method of manufacturing a laminated battery of any one of the fifth aspect to the seventh aspect, wherein, after having undergone the sealing step, the laminate exterior body has, at positions facing the substantially right-angled portions of the battery element, crest-folded bent portions at three or more places and trough-folded bent portions at one or more places.

In accordance with the present disclosure, there can be provided a laminated battery at which breakage of a metal layer of a laminate exterior body at positions facing substantially right-angled portions of a battery element is suppressed and at which good sealability of the battery element by the laminate exterior body is realized, and a battery module having the laminated battery, and a method of manufacturing the laminated battery.

### BRIEF DESCRIPTION OF THE DRAWINGS

FIG. 1 is a schematic perspective view exemplifying a battery element in an embodiment of the present disclosure;

FIG. 2 is a schematic perspective view exemplifying the battery element in a state of being sealed in a laminate exterior body in the embodiment of the present disclosure;

FIG. 3 is a schematic sectional view illustrating the X-X cross-section of FIG. 2;

FIG. 4 is a schematic sectional view for explaining a bending step in the embodiment of the present disclosure;

FIG. 5 is a schematic sectional view for explaining the bending step in the embodiment of the present disclosure;

FIG. 6 is a schematic sectional view illustrating a mold used in the bending step in the embodiment of the present disclosure;

FIG. 7 is a schematic top view illustrating a laminate exterior body at which bent portions are not formed at positions facing side surface members;

FIG. 8 is a schematic sectional view for explaining a bending step in another embodiment of the present disclosure;

FIG. 9 is a schematic sectional view for explaining the bending step in the another embodiment of the present disclosure;

FIG. 10 is a top view of a laminate film after an embossing step in Comparative Example 1, a cross-sectional view of the L-L cross-section in the top view, and a cross-sectional view of the M-M cross-section in the top view; and

FIG. 11 is a schematic sectional view illustrating an example of a solid-state battery.

### DETAILED DESCRIPTION

A battery of the present disclosure is described in detail hereinafter by using the drawings. The respective drawings described hereinafter are schematic illustrations, and sizes and shapes of respective portions are exaggerated when appropriate in order to facilitate understanding. Further, in the present specification, use of simply “above” and “below” when describing aspects in which a given member is disposed with respect to another member encompasses both cases in which the given member is disposed directly above or directly below the another member so as to contact the other member, and cases in which the given member is disposed above or below the another member with a separate member interposed therebetween, unless otherwise indicated.

A. Laminated Battery

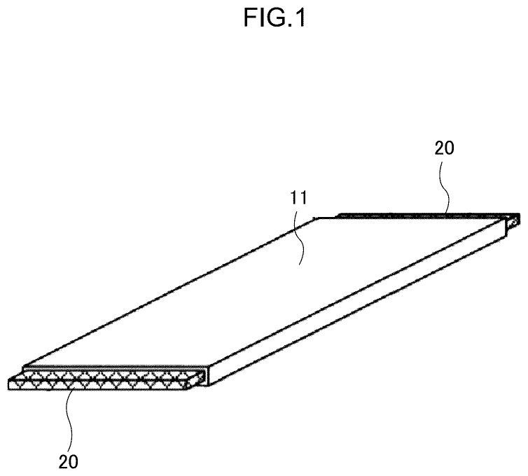

An embodiment of a laminated battery (hereinafter also simply called “battery”) relating to the present disclosure is described by using FIG. 1 through FIG. 3.

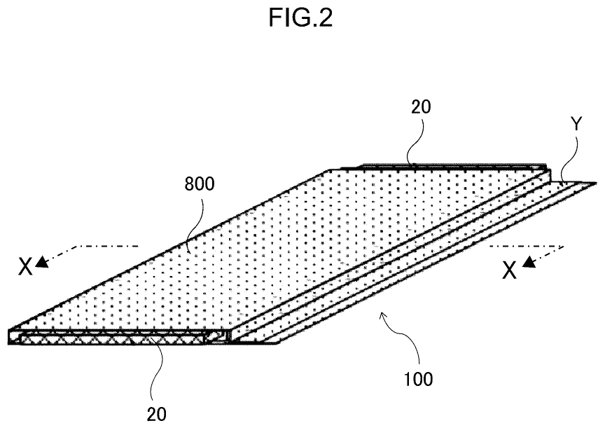

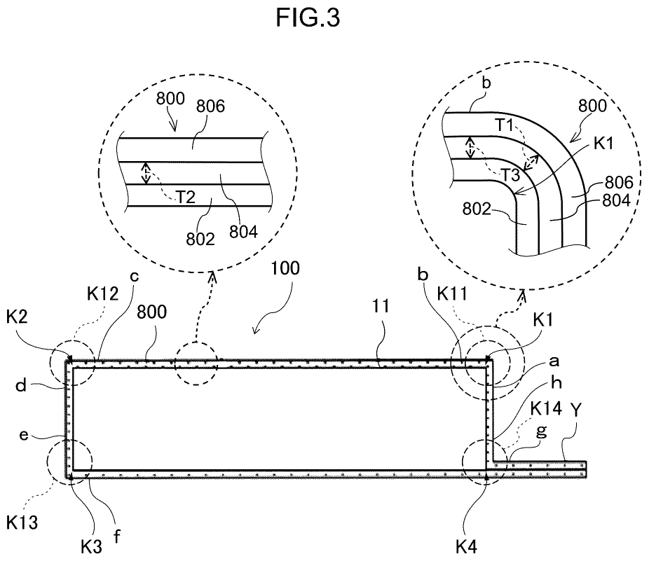

FIG. 1 is a schematic perspective view exemplifying a battery element in the embodiment of the present disclosure. FIG. 2 is a schematic perspective view exemplifying the battery element in a state of being sealed in a laminate exterior body in the embodiment of the present disclosure. FIG. 3 is a schematic sectional view illustrating the X-X cross-section of FIG. 2.

As illustrated in FIG. 1, a battery 100 (shown in FIG. 2) relating to the embodiment of the present disclosure has, as the battery element, an electrode body 11 and side surface members 20 (e.g., collector terminals) that are disposed at side surface portions of the electrode body 11. As illustrated in FIG. 2, this battery element is sealed by laminate film 800 that is the laminate exterior body. Namely, the electrode body 11 is sealed due to all of the four surfaces, which are other than the side surface portions at which the side surface members 20 are disposed, of the electrode body 11 being covered by the laminate film 800, and the side surface portions of the electrode body 11 being covered by the side surface members 20 and the laminate film 800. Partial regions, which are at the electrode body 11 sides of the side surface members 20, are covered by the laminate film 800.

The laminate film 800 is structured by a single film, and a resin layer and a metal layer are laminated in the laminate film 800. For example, the laminate film 800 is a layered body that is a three-layer structure having a fused resin layer 802, a metal layer 804 and a protective resin layer 806 in that order from the inner surface side that is the electrode body 11 side, as shown in FIG. 3. The laminate film 800 has a fused portion Y at which, in the state in which the laminate film 800 envelops the electrode body 11, the end portions of the laminate film 800 are superposed on one another and fused.

Note that FIG. 2 and FIG. 3 illustrate a form in which the laminate exterior body is structured by the one laminate film 800, but the present disclosure is not limited to this. In the present disclosure, the laminate exterior body may be structured by plural laminate films.

As illustrated in FIG. 3, the electrode body 11 that structures the battery element has four corner portions K1, K2, K3, K4 corresponding to the substantially right-angled portions. All of the four surfaces, which are located between two corner portions among the corner portions K1, K2, K3, K4, are horizontal portions that are horizontal shaped. Further, the respective positions of the laminate film 800 that face the corner portions K1, K2, K3, K4 of the electrode body 11 are bent portions K11, K12, K13, K14 that are all substantially right-angled. Note that the bent portions K11, K12, K13 are shapes that are bent in crest-folded shapes, and the one bent portion K14 is a shape that is bent in the direction of the fused portion Y in a trough-folded shape. Namely, at the positions facing the four corner portions K1, K2, K3, K4 corresponding to the substantially right-angled portions of the electrode body 11, the laminate film 800 has, at three or more places, bent portions that are crest-folded, and, at one or more places, a bent portion that is trough-folded.

Note that, although FIG. 3 illustrates a form in which all of the corner portions K1, K2, K3, K4 are right-angled, it suffices for the degrees of the substantially right-angled portions to be greater than or equal to 80° and less than or equal to 100°.

Here, at the battery 100 relating to the embodiment of the present disclosure, ratio (|T1−T2|/T2×100(%)) of the absolute value of the difference between thickness T1 of the metal layer 804 of the bent portions K11, K12, K13, K14 at the laminate film 800, and thickness T2 of the metal layer 804 at the laminate film 800 facing the four horizontal portions of the electrode body 11, with respect to T2 is less than or equal to 10%. Further, in the present disclosure, places of the metal layer 804, which satisfy the condition that the formula (|T1−T2|/T2×100(%)) is less than or equal to 10%, are greater than or equal to 80% of all of the places of the metal layer 804 of the laminate exterior body that face the substantially right-angled portions of the battery element. Note that, at the battery 100 illustrated in FIG. 3, T1 at all of the four bent portions K11, K12, K13, K14 is less than or equal to 10% with respect to T2. Namely, 100% of the places of the four bent portions K11, K12, K13, K14 satisfy the condition that the formula (|T1−T2|/T2×100(%)) is less than or equal to 10%.

Conventionally, at the time of manufacturing a laminated battery in which a battery element is sealed-in by a laminate exterior body, a process of forming shapes that run along the substantially right-angled portions is carried out in advance at the positions of the laminate exterior body that face the substantially right-angled portions of the battery element. Conventionally, an embossing step is carried out as the method of processing into shapes that run along the substantially right-angled portions. However, in a case of carrying out an embossing step, the embossed places of the laminate exterior body stretch. Therefore, at the positions of the laminate exterior body that face the substantially right-angled portions of the battery element, the thickness of the metal layer is thinner than at the other regions (e.g., the positions of the laminate exterior body facing the horizontal portions of the battery element). Therefore, there are cases in which breakage occurs at the places where the metal layer is thin at positions of the laminate exterior body which positions face the substantially right-angled portions, and the sealability of the battery element by the laminate exterior body deteriorates.

In contrast, at the battery 100 relating to the embodiment of the present disclosure, the difference in the thickness of the metal layer 804 at the bent portions K11, K12, K13, K14 of the laminate film 800 and at the positions thereof facing the horizontal portions of the electrode body 11 is small. Due thereto, breakage of the laminate film 800 at the bent portions K11, K12, K13, K14 can be suppressed, and the sealability of the electrode body 11 by the laminate film 800 can be improved.

(Difference in Thicknesses)

In the present disclosure, the difference between the thickness of the metal layer of the laminate exterior body facing the substantially right-angled portions of the battery element, and the thickness of the metal layer of the laminate exterior body facing the horizontal portions of the battery element, is small. Specifically, the ratio (|T1−T2|/T2×100(%)) of the difference between the thickness T1 of the metal layer of the laminate exterior body facing the substantially right-angled portions of the battery element, and the thickness T2 of the metal layer of the laminate exterior body facing the horizontal portions of the battery element, is less than or equal to 10%. In some embodiments, from the standpoints of suppressing breakage of the metal layer of the laminate exterior body at positions facing the substantially right-angled portions of the battery element, and improving the sealability of the battery element by the laminate exterior body, the ratio (|T1−T2|/T2×100(%)) of the differences is less than or equal to 5%, or less than or equal to 3%.

For the thickness T1 of the metal layer at the laminate exterior body facing the substantially right-angled portions of the battery element, at a position facing one of the substantially right-angled portions at the battery element (e.g., in FIG. 3, one bent portion among the bent portions K11, K12, K13, K14), the thickness of the metal layer at the laminate exterior body is measured at five arbitrary places, and the average value thereof is calculated and made to be the thickness T1. This is carried out for positions facing all of the substantially right-angled portions at the battery element (e.g., in FIG. 3, all of the bent portions K11, K12, K13, K14), and the thickness T1 at each position is determined. Further, for the thickness T2 of the metal layer at the laminate exterior body facing the horizontal portions of the battery element, at a position facing one horizontal portion at the battery element (e.g., in FIG. 3, one horizontal region located between two bent portions among the bent portions K11, K12, K13, K14), the thickness of the metal layer at the laminate exterior body is measured at five arbitrary places. Moreover, similarly, the thickness of the metal layer at five arbitrary places is measured for positions facing all of the horizontal portions at the battery element (e.g., in FIG. 3, all of the horizontal regions located between two bent portions among the bent portions K11, K12, K13, K14). The average value of the measured values at all of these measurement points is calculated and made to be the thickness T2.

In the present disclosure, the ratio (|T1−T2|/T2×100(%)) of the difference between the thickness T1 and the thickness T2 is in the above-described range at 80% or more of the positions among the positions that face all of the substantially right-angled portions at the battery element (e.g., in FIG. 3, all of the bent portions K11, K12, K13, K14). In some embodiments, the ratio (|T1−T2|/T2×100(%)) of the difference between the thickness T1 and the thickness T2 is in the above-described range at all of the positions (100% of the positions) among the positions that face the substantially right-angled portions.

Further, in some embodiments of the present disclosure, the difference between the thickness of the metal layer 804 at the laminate exterior body in vicinities of positions facing the substantially right-angled portions of the battery element, and the thickness of the metal layer 804 of the laminate exterior body facing the horizontal portions of the battery element, also is small. In some embodiments, specifically, the ratio (|T3−T2|/T2×100(%)) of the difference between thickness T3 of the metal layer 804 at the laminate exterior body at positions that face the horizontal portions of the battery element and are 1 mm from the positions facing the substantially right-angled portions of the battery element, and thickness T2 of the metal layer 804 at the laminate exterior body facing the horizontal portions of the battery element, is less than or equal to 10%. In some embodiments, note that, from the standpoints of suppressing breakage of the metal layer 804 of the laminate exterior body at positions facing the substantially right-angled portions of the battery element and in vicinities of these positions, and improving the sealability of the battery element by the laminate exterior body, the ratio (|T3−T2|/T2×100(%)) of the differences is less than or equal to 5%, or less than or equal to 3%.

Further, for the thickness T3 of the metal layer at the laminate exterior body at positions that face the horizontal portions of the battery element and that are 1 mm from the positions facing the substantially right-angled portions of the battery element, at a position that is apart by the above-described distance from a position facing one substantially right-angled portion of the battery element (e.g., in FIG. 3, one bent portion among the bent portions K11, K12, K13, K14), the thickness of the metal layer at the laminate exterior body is measured at five arbitrary places, and the average value thereof is calculated and made to be the thickness T3. This is carried out for positions facing all of the substantially right-angled portions at the battery element (e.g., in FIG. 3, all of the bent portions K11, K12, K13, K14), and the thickness T3 at each position is determined.

B. Method of Manufacturing Laminated Battery

The method of manufacturing the laminated battery relating to the present disclosure is a method of manufacturing a laminated battery that has a battery element including substantially right-angled portions and horizontal portions that are horizontal shaped, and a laminate exterior body that seals the battery element and at which at least a resin layer and a metal layer are laminated. The method of manufacturing the laminated battery has a bending step that forms bend lines by bending molding at positions of the laminate exterior body facing the substantially right-angled portions of the battery element at the time when the laminate exterior body seals the battery element, and a sealing step of sealing the battery element in the laminate exterior body that has the bend lines.

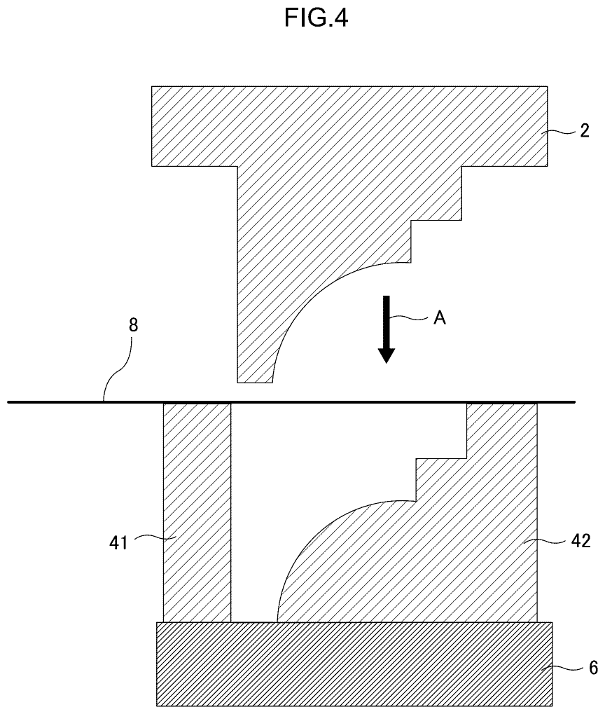

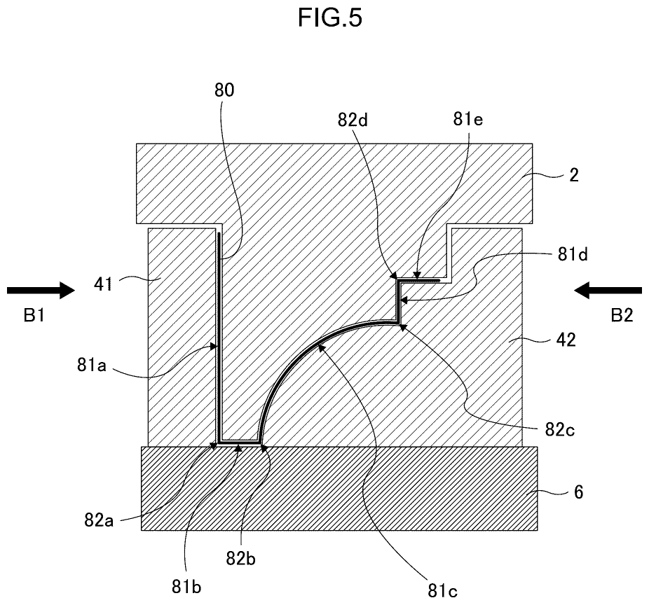

Here, an embodiment of the bending step in the method of manufacturing a laminated battery relating to the present disclosure is described by using FIG. 4 and FIG. 5. FIG. 4 and FIG. 5 are schematic sectional views for explaining the bending step in an embodiment of the present disclosure.

As illustrated in FIG. 4, the bending step in an embodiment of the present disclosure uses a mold having an upper mold 2, and a lower mold that has a left core 41, a right core 42 and a stand 6. A film 8 before the bending step, which is to become the laminate exterior body, is placed on the left core 41 and the right core 42 at the lower mold. Next, the upper mold 2 is lowered in the arrow A direction with respect to the film 8. Moreover, as illustrated in FIG. 5, by applying pressure from the left core 41 to the film 8 in the arrow B1 direction, and applying pressure from the right core 42 to the film 8 in the arrow B2 direction, the bending step is carried out, and a laminate film 80 of the shape illustrated in FIG. 5 is obtained.

The laminate film 80 after the bending step has four bent portions 82a, 82b, 82c, 82d, and five surfaces 81a, 81b, 81c, 81d, 81e. After the electrode body 11 is sealed, the bent portion 82a of the laminate film 80 corresponds to the bent portion K13 in FIG. 3, the bent portion 82b corresponds to the bent portion K12 in FIG. 3, the bent portion 82c corresponds to the bent portion K11 in FIG. 3, and the bent portion 82d corresponds to the bent portion K14 in FIG. 3. Further, the surfaces 81a, 81b, 81c, 81d are the surfaces that structure the horizontal portions, and the surface 81e is the surface that is superposed with the end portion of the surface 81a and structures the fused portion Y.

At the mold illustrated in FIG. 4 and FIG. 5, one of the surfaces that contact the laminate film 80 at the right core 42 of the lower mold, and specifically, the region that forms the surface 81c, is an arc-shaped surface.

The mold that is used in the bending step has an arc-shaped surface at the region of the laminate exterior body at a position facing a horizontal portion of the battery element at the time when the battery element is sealed. Due thereto, the bending step can be carried out all at once. Further, due to the mold having the arc-shaped surface, the accuracy of the positions of the bent portions can be improved as compared with a mold that does not have an arc-shaped surface.

Note that the mold may have two or more arc-shaped surfaces at regions of the laminate exterior body at positions facing horizontal portions of the battery element at the time when the battery element is sealed.

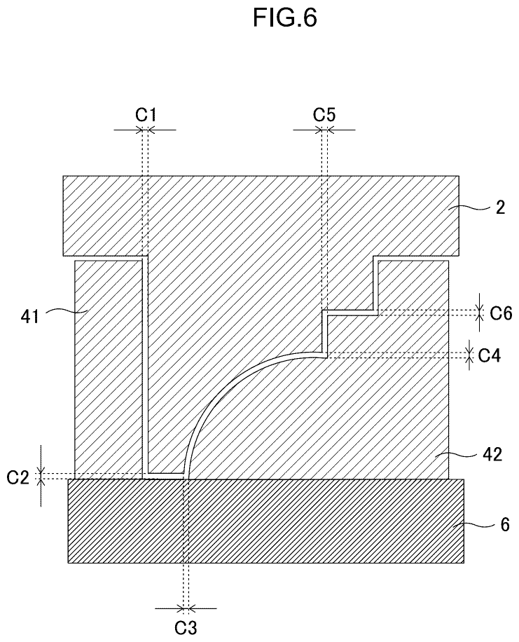

The clearances (i.e., the gaps between the molds) at the time of carrying out the bending step by using the mold illustrated in FIG. 4 and FIG. 5, i.e., at the time of lowering the upper mold 2 with respect to the film 8 in the arrow A direction, and then applying pressure from the left core 41 to the film 8 in the arrow B1 direction, and applying pressure from the right core 42 to the film 8 in the arrow B2 direction, and carrying out the bending step, are described. FIG. 6 is a schematic sectional view for explaining the clearances at the mold, and illustrates only the upper mold 2, and the lower mold that has the left core 41, the right core 42 and the stand 6, without illustrating the laminate film.

In some embodiments, the width of clearances C1, C2, C3 illustrated in FIG. 6 be 0 μm. In some embodiments, namely, at the position of the clearance C1, the upper mold 2 and the left core 41 contact one another in a case in which the laminate film does not exist therebetween. In some embodiments, similarly, at the position of the clearance C2, the upper mold 2 and the stand 6 contact one another in a case in which the laminate film does not exist therebetween. In some embodiments, at the position of the clearance C3, the upper mold 2 and the right core 42 contact one another in a case in which the laminate film does not exist therebetween. When the battery element (e.g., the electrode body 11 and the side surface members 20 in FIG. 2) is sealed by the laminate film, it is desirable that the bent portions are soundly formed in particular at two points that are bent portions 82a and 82b of the laminate film 80 in FIG. 5. Due to the widths of the clearances C1, C2, C3 being 0 μm, formation of the two points that are the bent portions 82a and 82b can be carried out well.

In some embodiments, on the other hand, the widths of clearances C4, C5, C6 shown in FIG. 6 are greater than or equal to (the thickness of the laminate film+10 μm) and less than or equal to (the thickness of the laminate film+100 μm), or greater than or equal to (the thickness of the laminate film+30 μm) and less than or equal to (the thickness of the laminate film+70 μm). Due to the widths of clearances C4, C5, C6 being in the above-described range, the occurrence of damage to the laminate film due to pressure from the mold at the bent portions 82c, 82d can be suppressed.

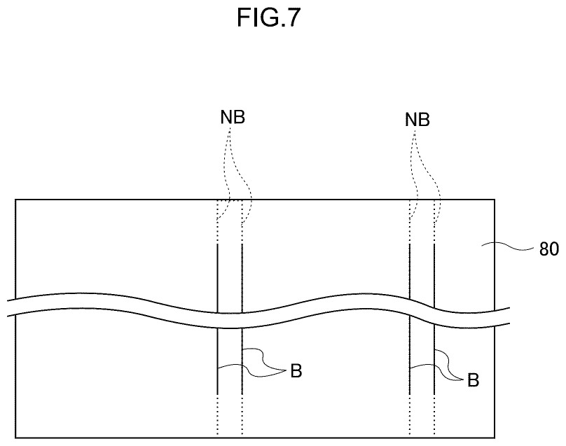

In some embodiments, note that, at the time of forming the bent portions 82a, 82b, 82c, 82d at the laminate film 80 in the bending step, the bent portions is not formed at positions facing the side surface members 20 of the laminate film 80. In some embodiments, namely, as illustrated in FIG. 7, bend lines B is formed at the positions (the positions that become the bent portions K11, K12, K13, K14) of the laminate film 80 that face the four corner portions K1, K2, K3, K4 corresponding to the substantially right-angled portions of the electrode body 11, and, on the other hand, to make the positions that face the side surface members 20 be regions NB at which bend lines are not formed. Here, the positions of the laminate film 80 that face the side surface members correspond to regions of the laminate film 800 that cover portions of the electrode body 11 sides of the side surface members 20, at the battery 100 in which the electrode body 11 is covered by the laminate film 800 illustrated in FIG. 2.

In the bending step, the bent portions (e.g., the bend lines B) are formed at positions facing the substantially right-angled portions at the battery element, and moreover, the bend lines can also be formed at positions facing the side surface members that correspond to extended lines thereof. However, the side surface members (e.g., collector terminals) generally are members that are small-sized as compared with the electrode body that structures the battery element. Therefore, the bend lines that are formed at positions facing the side surface members do not face the corner portions of the side surface members, and remain as traces of the bend lines at the positions that do not face the corner portions of the side surface members. There are cases in which these traces of the bend lines become a cause of breakage at the laminate exterior body. In some embodiments, therefore, in the bending step, bend lines are not formed at positions facing the side surface members of the laminate exterior body. Due thereto, breakage of the laminate film due to traces of bend lines can be suppressed.

Note that a method using a mold of a width that is narrower than the width of the film 8 before the bending step is an example of a method of not forming bent portions at positions facing the side surface members 20 of the laminate film 80 in the bending step. Namely, by using a mold that has the same width as the length of the bend lines B illustrated in FIG. 7, and the film 8 whose width is wider than this mold, the bending step can be carried out without forming bent portions at the positions of the laminate film 80 that face the side surface members 20.

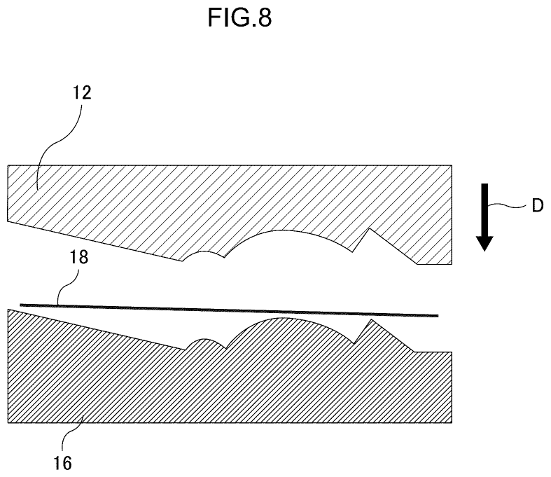

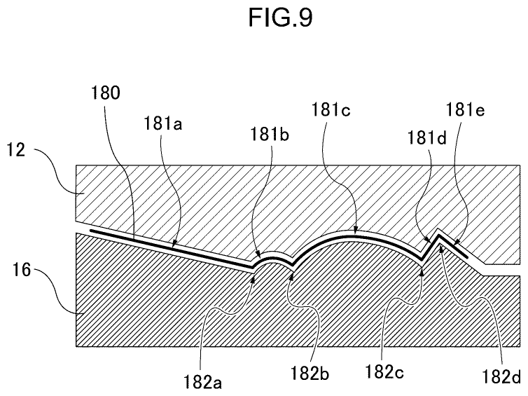

Next, another embodiment of the bending step in the method of manufacturing the laminated battery relating to the present disclosure is described by using FIG. 8 and FIG. 9. FIG. 8 and FIG. 9 are schematic sectional views for explaining the bending step in the another embodiment of the present disclosure.

As illustrated in FIG. 8, the bending step in the another embodiment of the present disclosure uses a mold having an upper mold 12 and a lower mold 16. First, a film 18 before the bending step that is to become the laminate exterior body is placed on the lower mold 16. Next, due to the upper mold 12 being lowered in the arrow D direction with respect to the film 18 and applying pressure, the bending step is carried out, and laminate film 180 of the shape illustrated in FIG. 9 is obtained.

The laminate film 180 after the bending step has four bent portions 182a, 182b, 182c, 182d and five surfaces 181a, 181b, 181c, 181d, 181e. After the electrode body 11 is sealed, the bent portion 182a of the laminate film 180 corresponds to the bent portion K13 in FIG. 3, the bent portion 182b corresponds to the bent portion K12 in FIG. 3, the bent portion 182c corresponds to the bent portion K11 in FIG. 3, and the bent portion 182d corresponds to the bent portion K14 in FIG. 3. Further, the surfaces 181a, 181b, 181c, 181d are the surfaces that structure the horizontal portions, and the surface 181e is the surface that is superposed with the end portion of the surface 181a and structures the fused portion Y.

C. Battery Members

(1) Battery Element

The battery element of the present disclosure has an electrode body for example. Usually, the electrode body has a positive electrode collector, a positive electrode active material layer, an electrolyte layer, a negative electrode active material layer and a negative electrode collector, in that order in the thickness direction.

The positive electrode active material layer has at least a positive electrode active material. The positive electrode active material layer may further include at least one of a conductive material, an electrolyte, and a binder. The shape of the positive electrode active material is particulate-shaped for example. Oxide active materials are examples of the positive electrode active material. Further, sulfur (S) may be used as the positive electrode active material.

In some embodiments, the positive electrode active material contains a lithium composite oxide. The lithium composite oxide may contain at least one type selected from the group consisting of F, Cl, N, S, Br and I. Further, the lithium composite oxide may have a crystal structure belonging to at least one space group selected from space groups R-3m, Immm, and P63-mmc (also called P63mc, P6/mmc). In the lithium composite oxide, the main sequence of a transition metal, oxygen and lithium may be an O2-type structure.

Examples of lithium composite oxides having a crystal structure belonging to R-3m are compounds expressed by LiₓMe_{y}O_{α}X_{β} (Me represents at least one type selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si and P, and X represents at least one type selected from the group consisting of F, Cl, N, S, Br and I, and 0.5≤x≤1.5, 0.5≤y≤1.0, 1≤α<2, 0<β≤1 are satisfied).

Examples of lithium composite oxides having a crystal structure belonging to Immm are composite oxides expressed by Liₓ₁M¹A¹₂ (1.5≤x1≤2.3 is satisfied, M¹ includes at least one type selected from the group consisting of Ni, Co, Mn, Cu and Fe, A¹ includes at least oxygen, and the ratio of the oxygen contained in A¹ is greater than or equal to 85 atom %) (a specific example is Li₂NiO₂), and composite oxides expressed by Liₓ₁M^{1A}₁₋ₓ₂M^{1B}ₓ₂O_{2-y}A²_{y} (0≤x2≤0.5 and 0≤y≤0.3, at least one of x2 and y is not 0, M^{1A} represents at least one type selected from the group consisting of Ni, Co, Mn, Cu and Fe, M^{1B} represents at least one type selected from the group consisting of Al, Mg, Sc, Ti, Cr, V, Zn, Ga, Zr, Mo, Nb, Ta and W, and A2 represents at least one type selected from the group consisting of F, Cl, Br, S and P).

Examples of lithium composite oxides having a crystal structure belonging to P63-mmc are composite oxides expressed by M₁ₓM_{2y}O₂ (M1 represents an alkali metal (in some embodiments, at least one of Na and K is selected), M2 represents a transition metal (in some embodiments, at least one type selected from the group consisting of Mn, Ni, Co and Fe is selected), and x+y satisfies 0<x+y≤2).

Examples of lithium composite oxides having an O2-type structure are composite oxides expressed by Liₓ[Li_{α}(MnₐCo_{b}M_{c})_{1-α}]O₂ (0.5<x<1.1, 0.1<α<0.33, 0.17<a<0.93, 0.03<b<0.50, 0.04<c<0.33, and M represents at least one type selected from the group consisting of Ni, Mg, Ti, Fe, Sn, Zr, Nb, Mo, W and Bi). Specific examples are Li_{0.744}[Li_{0.145}Mn_{0.625}Co_{0.115}Ni_{0.115}]O₂ and the like.

In some embodiments, in addition to the positive electrode active material, the positive electrode includes a solid electrolyte selected from the group of solid electrolytes consisting of sulfide solid electrolytes, oxide solid electrolytes, and halide solid electrolytes. In some embodiments, a form in which at least a portion of the surface of the positive electrode active material is covered by a sulfide solid electrolyte, an oxide solid electrolyte or a halide solid electrolyte is selected. In some embodiments, Li_{6-(4-x)b} (Ti₁₋ₓAlₓ)_{b}F₆ (0<x<1, 0<b≤1.5) [LTAF electrolyte] is selected as the halide solid electrolyte that covers at least a portion of the surface of the positive electrode active material.

Carbon materials are examples of the conductive material. The electrolyte may be a solid electrolyte or may be a liquid electrolyte. The solid electrolyte may be an organic solid electrolyte such as a gel electrolyte or the like, or may be an inorganic solid electrolyte such as an oxide solid electrolyte, a sulfide solid electrolyte or the like. Liquid electrolytes (electrolyte liquids) include, for example, supporting salts such as LiPF₆ or the like, and solvents such as carbonate solvents and the like. Further, examples of the binder are rubber binders and fluoride binders.

The negative electrode active material layer includes at least a negative electrode active material. The negative electrode active material layer may further include at least one of a conductive material, an electrolyte, and a binder. Examples of the negative electrode active material are metal active materials such as Li, Si and the like, carbon active materials such as graphite and the like, and oxide active materials such as Li₄Ti₅O₁₂ and the like. The shape of the negative electrode active material is, for example, particulate-shaped or foil-shaped. The conductive material, the electrolyte and the binder are similar to those described above.

The electrolyte layer is disposed between the positive electrode active material layer and the negative electrode active material layer, and contains at least an electrolyte. The electrolyte may be a solid electrolyte or may be a liquid electrolyte. In some embodiments, the electrolyte layer be a solid electrolyte layer. The electrolyte layer may have a separator.

In some embodiments, the solid electrolyte includes at least one type of solid electrolyte selected from the group of solid electrolytes consisting of sulfide solid electrolytes, oxide solid electrolytes and halide solid electrolytes.

In some embodiments, the sulfide solid electrolyte contains sulfur (S) as the main component that is an anion element, and further, in some embodiments, contains, for example, the element Li, element A and the element S. Element A is at least one type selected from the group consisting of P, As, Sb, Si, Ge, Sn, B, Al, Ga and In. The sulfide solid electrolyte may further contain at least one of O and a halogen element. Examples of the halogen element (X) are F, Cl, Br, I and the like. The composition of the sulfide solid electrolyte is not particularly limited, and examples are xLi₂S·(100−x)P₂S₅ (70≤x≤80) and yLiI·zLiBr·(100−y−z)(xLi₂S·(1−x)P₂S₅) (0.7≤x≤0.8, 0≤y≤30, 0≤z≤30). The sulfide solid electrolyte may have the composition expressed by following general formula (1).

Li₄₋ₓGe₁₋ₓPₓS₄(0<x<1) (1)

In formula (1), at least a portion of Ge may be substituted by at least one selected from the group consisting of Sb, Si, Sn, B, Al, Ga, In, Ti, Zr, V and Nb. Further, at least a portion of P may be substituted by at least one selected from the group consisting of Sb, Si, Sn, B, Al, Ga, In, Ti, Zr, V and Nb. A portion of Li may be substituted by at least one selected from the group consisting of Na, K, Mg, Ca and Zn. A portion of S may be substituted by a halogen. The halogen is at least one of F, Cl, Br and I.

In some embodiments, the oxide solid electrolyte contains oxygen (O) as the main component that is an anion element, and, for example, may contain Li, element Q (Q represents at least one of Nb, B, Al, Si, P, Ti, Zr, Mo, W and S), and O. Examples of the oxide solid electrolyte are garnet type solid electrolytes, perovskite type solid electrolytes, NASICON type solid electrolytes, Li-P-O solid electrolytes, Li-B-O solid electrolytes, and the like. Examples of garnet type solid electrolytes are Li₇La₃Zr₂O₁₂, Li₇₋ₓLa₃(Zr₂₋ₓNbₓ)O₁₂ (0≤x≤2), Li₅La₃Nb₂O₁₂, and the like. Examples of perovskite type solid electrolytes are (Li,La)TiO₃, (Li,La)NbO₃, (Li,Sr)(Ta,Zr)O₃ and the like. Examples of NASICON type solid electrolytes are Li(Al,Ti)(PO₄)₃, Li(Al,Ga)(PO₄)₃, and the like.

Examples of Li-P-O solid electrolytes are Li₃PO₄, LIPON (compounds in which some of the O in Li₃PO₄ is substituted with N). Examples of Li-B-O solid electrolytes are Li₃BO₃, compounds in which some of the O in Li₃BO₃ is substituted with C, and the like.

As the halide solid electrolyte, solid electrolytes containing Li, M and X (M represents at least one of Ti, Al and Y, and X represents F, Cl or Br) are suitable. In some embodiments, specifically, Li_{6-3z}Y_{z}X₆ (X represents Cl or Br, and z satisfies 0<z<2) and Li_{6-(4-x)b}(Ti₁₋ₓAlₓ)_{b}F₆ (0≤X<1, 0<b≤1.5) are selected. In some embodiments, among Li_{6-3z}Y_{z}X₆, from the standpoint of having lithium ion conductivity, Li₃YX₆ (X represents Cl or Br) is selected, or and Li₃YCl₆ is selected. In some embodiments, further, from standpoints such as, for example, suppressing oxidative decomposition of the sulfide solid electrolyte and the like, Li_{6-(4-x)b}(Ti₁₋ₓAlₓ)_{b}F₆ (0<x<1, 0<b≤1.5) may be contained together with a solid electrolyte such as a sulfide solid electrolyte or the like.

The positive electrode collector carries out power collection of the positive electrode active material layer. In some embodiments, examples of the material of the positive electrode collector are metals such as aluminum, SUS, nickel, iron, titanium and the like, and carbon and the like, and an aluminum alloy film or an aluminum film is selected. The aluminum alloy film or aluminum film may be manufactured by using a powder. Examples of the form of the positive electrode collector are the form of a foil and the form of a mesh. The positive electrode collector has a positive electrode tab for connection with a positive electrode collector terminal.

The negative electrode collector carries out power collection of the negative electrode active material layer. Examples of the material of the negative electrode collector are metals such as copper, SUS, nickel and the like. Examples of the form of the negative electrode collector are the form of a foil and the form of a mesh. The negative electrode collector has a negative electrode tab for connection with a negative electrode collector terminal.

The battery element of the present disclosure may have side surface members for example. The side surface members are disposed at the side surface portions of the electrode body. In some embodiments, the side surface members are not particularly limited provided that they are members disposed at the side surface portions of the electrode body, but may be collector terminals. A collector terminal is a terminal having a collector portion at at least a portion thereof. For example, the collector portion is electrically connected to a tab at the electrode body. The entire collector terminal may be a collector portion, or a portion of the collector terminal may be a collector portion. Further, the side surface members may be exterior members that do not have a power collecting function.

Metals such as SUS and the like are examples of the material of the side surface members. Further, a form in which the side surface member has a covering resin layer on the surface thereof that contacts the laminate film at the obverse, is an example. Examples of the material of the covering resin layer are olefin resins such as polypropylene (PP), polyethylene (PE) and the like. The thickness of the covering resin layer is, for example, greater than or equal to 40 μm and less than or equal to 150

(3) Laminate Exterior Body

A laminate film is an example of the laminate exterior body of the present disclosure. The laminate film has at least a structure having a resin layer and a metal layer, and, for example, has a structure having a fused resin layer (thermal bonding layer) on one surface of a metal layer (the inner side surface forming the fused portion). Further, the laminate film may have a fused resin layer (thermal bonding layer), a metal layer and a protective resin layer in that order along the thickness direction. Examples of the material of the fused resin layer (thermal bonding layer) are olefin resins such as polypropylene (PP), polyethylene (PE) and the like. Examples of the material of the metal layer are aluminum, aluminum alloys, and stainless steel. Examples of the material of the protective resin layer are polyethylene terephthalate (PET) and nylon. The thickness of the fused resin layer (thermal bonding layer) is, for example, greater than or equal to 40 μm and less than or equal to 100 The thickness of the metal layer is, for example, greater than or equal to 30 μm and less than or equal to 60 The thickness of the protective resin layer is, for example, greater than or equal to 20 μm and less than or equal to 60 The thickness of the entire laminate film is, for example, greater than or equal to 70 μm and less than or equal to 220

(4) Battery

In some embodiments, the battery in the present disclosure is typically a lithium ion secondary battery, and may be a solid-state battery. So-called all-solid-state batteries that use an inorganic solid electrolyte as the electrolyte are included among solid-state batteries.

The structure of the solid-state battery is a layered structure of a positive electrode/a solid electrolyte layer/a negative electrode.

The positive electrode has a positive electrode active material layer and a collector, and the negative electrode has a negative electrode active material layer and a collector.

The solid electrolyte layer may be a single-layer structure, or may be a multilayer structure of two or more layers.

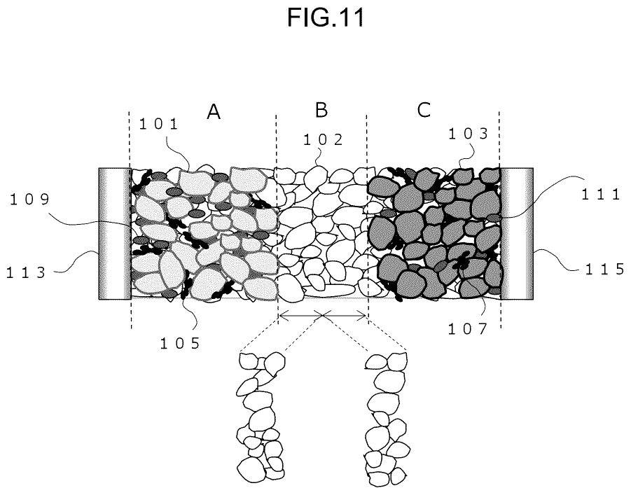

For example, the solid-state battery may have the cross-sectional structure illustrated in FIG. 11, and a solid electrolyte layer B may be a two-layer structure as illustrated in FIG. 11. FIG. 11 is a schematic sectional view illustrating an example of a solid-state battery. The solid-state battery illustrated in FIG. 11 has a negative electrode including a negative electrode collector 113 and a negative electrode active material layer A, and the solid electrolyte layer B, and a positive electrode including a positive electrode collector 115 and a positive electrode active material layer C. The negative electrode active material layer A includes a negative electrode active material 101, a conduction assistant 105, and a binder 109. The solid electrolyte layer B includes a solid electrolyte 102. The positive electrode active material layer C includes a covered positive electrode active material 103, a conduction assistant 107 and a binder 111. The surface of the positive electrode active material at the covered positive electrode active material 103 is covered by LTAF electrolyte or LiNbO₃ electrolyte.

Further, the solid-state battery may be structured such that the layer end surfaces (side surfaces) of a layered structure of a positive electrode/a solid electrolyte layer/a negative electrode are sealed by a resin. The collector of the electrode may be a structure in which a shock-absorbing layer, an elastic layer or a PTC (Positive Temperature Coefficient) thermistor layer is disposed on the surface of the collector.

An example of the intended use of the battery is the power source of a vehicle such as, for example, a hybrid vehicle (HEV), a plug-in hybrid vehicle (PHEV), an electric vehicle (BEV), a gasoline-powered vehicle, a diesel-powered vehicle or the like. In some embodiments, the battery is used as the power source for driving of an REV, PHEV or BEV. Further, the battery of the present disclosure may be used as the power source of a moving body other than a vehicle (e.g., a train, a boat, an airplane), or may be used as the power source of an electronic product such as an information processing device or the like.

D. Battery Module

The battery module relating to the present disclosure has plural batteries that are stacked in the thickness direction. The battery is the battery described in above “A. Laminated Battery”.

Because the battery of the present disclosure is similar to the contents described in above “A. Laminated Battery”, description thereof is omitted here. Further, the battery module of the present disclosure may have a restraining jig that restrains the plural batteries in the thickness direction. The type of restraining jig is not particularly limited, and an example is a jig that applies restraining torque by bolts. The restraining pressure applied by the restraining jig is, for example, greater than or equal to 1 MPa and less than or equal to 50 MPa.

The present disclosure is not limited to the above-described embodiments. The above embodiments are illustrative, and all forms that have substantially the same structures as, and exhibit similar operations and effects as, the technical concepts put forth in the claims of the present disclosure are included in the technical scope of the present disclosure.

### EXAMPLES

The present disclosure will be described more specifically by illustration of the following Examples.

### Example 1

As the laminate film, a layered body was prepared that had a fused resin layer formed from a polypropylene (PP) layer of 40 μm and an acid-modified polypropylene (PPa) layer of 40 μm, a metal layer formed from an aluminum (Al) layer of 40 μm, and a protective resin layer formed from a stretched nylon (ONy) layer of 15 μm, an adhesive layer of 1 μm and a polyethylene terephthalate (PET) layer of 12 μm, in that order from the inner surface side that became the electrode body side at the time of sealing the electrode body.

A bending step was carried out on the laminate film by using the mold illustrated in FIG. 4 and FIG. 5. Namely, the laminate film was placed on the left core 41 and the right core 42 at the lower mold, and next, the upper mold 2 was lowered in the arrow A direction. Moreover, as illustrated in FIG. 5, the bending step was carried out due to pressure being applied in the arrow B1 direction by the left core 41 and pressure being applied in the arrow B2 direction by the right core 42, and a laminate film of the shape illustrated in FIG. 5 was obtained. The laminate film after the bending step has the four bent portions 82a, 82b, 82c, 82d and the five surfaces 81a, 81b, 81c, 81d, 81e.

Next, the electrode body 11 having collector terminals, which serve as the side surface members 20, at the side surfaces was sealed by using the laminate film after the bending step, and a battery was obtained.

At the battery, the thickness of the metal layer (Al layer) at each of the bent portions K11, K12, K13, K14 in FIG. 3 was measured at five arbitrary places, and the average value thereof was calculated and used as thickness T1 of the metal layer at the respective bent portions K11, K12, K13, K14.

Further, for each of the total of four horizontal regions located between two bent portions among the bent portions K11, K12, K13, K14 of FIG. 3, the thickness of the metal layer of the laminate film was measured at five arbitrary places, and the average value of the measured values at the total of 20 places (the measured points at 5 places×the four horizontal regions) was calculated and used as thickness T2 of the metal layer at the horizontal portions. The determined results are illustrated in Table 1.

### Comparative Example 1

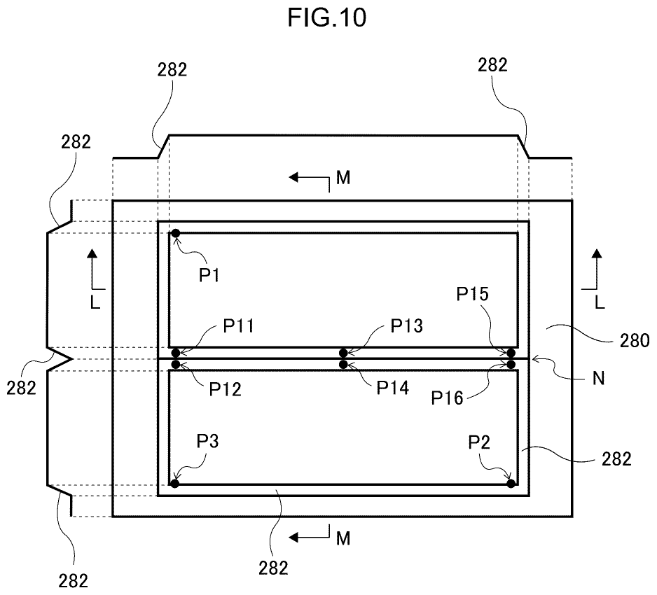

By using a laminate film that was the same as that of Example 1, the laminate film was processed into the shape illustrated in FIG. 10 by an embossing step. Note that FIG. 10 shows a top view of a laminate film 280 after the embossing step in Comparative Example 1, a cross-sectional view of the L-L cross-section in the top view (i.e., the drawing at the upper side in FIG. 10), and a cross-sectional view of the M-M cross-section in the top view (i.e., the drawing at the left side in FIG. 10). Note that a laminated battery is obtained due to the laminate film 280 of the shape illustrated in FIG. 10 being folded-over at a center fold-over portion N, and an electrode body being sealed within the concave portions that face one another, and the end portions being laminated.

The laminate film 280 has embossed portions 282. The thickness of the metal layer (Al layer) at respective points P1, P2, P3 among the positions corresponding to the folded-over portion were measured at three arbitrary places, and the average value thereof was calculated and used as thickness T1 of the metal layer at the points P1, P2, P3.

Further, the thickness of the metal layer of the laminate film 280 in a vicinity of the center at a horizontal portion in FIG. 10 (i.e., in a vicinity of the central position that is the furthest away from all of the embossed portions at the horizontal portion surrounded by the embossed portions) was measured at three arbitrary places, and the average value thereof was calculated and used as the thickness T2 of the metal layer at the horizontal portion.

The determined results are illustrated in Table 2.

TABLE 1

| | thickness of metal layer [μm] | | | | |
|---|---|---|---|---|---|
| | bent portion T1 | | | | horizontal |
| | (difference (\|T1 − T2\|/T2 × 100)(%)) | | | | portion |
| | K11 | K12 | K13 | K14 | T2 |
| Example 1 | 40 | 38 | 37 | 38 | 40 |
| | (0%) | (5.0%) | (7.5%) | (5.0%) | |

TABLE 2

| | thickness of metal layer [μm] | | | |
|---|---|---|---|---|
| | bent portion T1 | | | horizontal |
| | (difference (\|T1 − T2\|/T2 × 100)(%)) | | | portion |
| | P1 | P2 | P3 | T2 |
| Comparative | 30 | 28 | 24 | 40 |
| Example 1 | (25.0%) | (30.0%) | (40.0%) | |

(Metal Layer Thickness at Horizontal Portion in Vicinity of Bent Portion)

Next, the thickness of the metal layer at a horizontal portion in the vicinity of a bent portion at the laminate film was measured.

First, in Comparative Example 1, at the laminate film 280, thickness T3 of the metal layer (Al layer) was measured at one place of each of points P11, P12, P13, P14, P15, P16 that correspond to the horizontal portion of the trough portion formed in a vicinity of the center fold-over portion N, i.e., at points positioned midway between a bent portion at the bottom side and a bent portion at the peak side at the trough portion.

Further, in Example 1, at the laminate film, thickness T3 of the metal layer (Al layer) at the horizontal portions of 1 mm at the both sides from the bent portions K11, K12, K13, K14 were measured at one place each. Accordingly, there were a total of eight places of measurement, corresponding to a, b, c, d, e, f, g, h in FIG. 3.

The determined results are shown in Table 3 and Table 4.

TABLE 3

| | thickness of metal layer [μm] | | | | | | | | |
|---|---|---|---|---|---|---|---|---|---|
| | T3 of horizontal portion in vicinity of bent portion | | | | | | | | horizontal |
| | (difference (\|T3-T2\|/T2X 100)(%)) | | | | | | | | portion |
| | a | b | C | d | e | f | g | h | T2 |
| Example 1 | 39 | 40 | 40 | 40 | 39 | 40 | 40 | 40 | 40 |
| | (2.5%) | (0%) | (0%) | (0%) | (2.5%) | (0%) | (0%) | (0%) | |

TABLE 4

| | thickness of metal layer [μm] | | | | | | |
|---|---|---|---|---|---|---|---|
| | T3 of horizontal portion in vicinity of bent portion | | | | | | horizontal |
| | (difference (\|T3-T2\|/T2X 100) (%)) | | | | | | portion |
| | P11 | P12 | P13 | P14 | P15 | P16 | T2 |
| Comparative | 27 | 31 | 28 | 28 | 27 | 26 | 40 |
| Example 1 | (32.5%) | (22.5%) | (30.0%) | (30.0%) | (32.5%) | (35.0%) | |

As shown in Table 1 and Table 2, in Example 1 in which bent portions were formed at the laminate film by a bending step, as compared with Comparative Example 1 in which bent portions were formed by an embossing step, the thickness of the metal layer at the bent portions becoming thin is suppressed.

Further, as illustrated in Table 3 and Table 4, with regard to the metal layer thickness of the horizontal portions in vicinities of the bent portions as well, in Example 1 in which bent portions were formed at the laminate film by a bending step, as compared with Comparative Example 1 in which bent portions were formed by an embossing step, the thickness becoming thin is suppressed.

From the above-described results, it is observed that, in Example 1, breakage of the metal layer at the bent portions of the laminate film is suppressed, as compared with Comparative Example 1.

What is claimed is:

1. A laminated battery, comprising:
a battery element; and
a laminate exterior body that seals the battery element,
wherein:
the laminate exterior body includes at least a resin layer and a metal layer that are laminated,
the battery element includes substantially right-angled portions having angles greater than or equal to 80° and less than or equal to 100°, and horizontal portions that are horizontal shaped, and
at 80% or more of areas of the metal layer that face the substantially right-angled portions of the battery element, a thickness T1 of the metal layer satisfies a relationship of the following formula with respect to a thickness T2 of the metal layer of the laminate exterior body that faces the horizontal portions of the battery element:

|T1−T2|/T2×100(%)≤10%.

2. The laminated battery of claim 1, wherein a ratio (|T3−T2|/T2×100(%)) of a difference between a thickness T3 of the metal layer at positions that face the horizontal portions of the battery element and are 1 mm from positions that face the substantially right-angled portions of the battery element, and the thickness T2 of the metal layer of the laminate exterior body that faces the horizontal portions of the battery element, is less than or equal to 10%.

3. The laminated battery of claim 1, wherein, at positions facing the substantially right-angled portions of the battery element, the laminate exterior body has crest-folded bent portions at three or more places and trough-folded bent portions at one or more places.

4. A battery module having a plurality of laminated batteries that are stacked in a thickness direction, wherein each of the laminated batteries comprises the laminated battery of claim 1.

5. A method of manufacturing a laminated battery having:
a battery element including substantially right-angled portions having angles greater than or equal to 80° and less than or equal to 100°, and horizontal portions that are horizontal shaped; and
a laminate exterior body that seals the battery element, and at which at least a resin layer and a metal layer are laminated,
the method comprising:
a bending step of forming bend lines by bending molding at positions of the laminate exterior body that face the substantially right-angled portions of the battery element at a time at which the laminate exterior body seals the battery element; and
a sealing step of sealing the battery element by the laminate exterior body that has the bend lines.

6. The method of manufacturing a laminated battery of claim 5, wherein:
the battery element includes an electrode body, and side surface members disposed at side surface portions of the electrode body, and
in the bending step, at a time of forming the bend lines at the laminate exterior body, the bend lines are not formed at positions of the laminate exterior body that face the side surface members.

7. The method of manufacturing a laminated battery of claim 5, wherein:
a mold, which has an arc-shaped surface at at least one surface that contacts the laminate exterior body, is used in the bending molding in the bending step, and
the arc-shaped surface contacts positions of the laminate exterior body that face a horizontal portion of the battery element at the time at which the laminate exterior body seals the battery element.

8. The method of manufacturing a laminated battery of claim 5, wherein, after having undergone the sealing step, the laminate exterior body has, at positions facing the substantially right-angled portions of the battery element, crest-folded bent portions at three or more places and trough-folded bent portions at one or more places.
